(19) United States
(12) Patent Application Publication
(10) Pub. No.: US 2022/0102063 A1
(43) Pub. Date: Mar. 31, 2022

(54) COIL COMPONENT

(71) Applicant: Murata Manufacturing Co., Ltd., Kyoto-fu (JP)

(72) Inventors: Yuki KANBE, Nagaokakyo-shi (JP); Tomoyuki WADA, Nagaokakyo-shi (JP); Kazuto SHIBUYA, Nagaokakyo-shi (JP); Seiya YUKI, Nagaokakyo-shi (JP)

(73) Assignee: Murata Manufacturing Co., Ltd., Kyoto-fu (JP)

(21) Appl. No.: 17/469,770

(22) Filed: Sep. 8, 2021

(30) Foreign Application Priority Data
Sep. 30, 2020 (JP) 2020-165297

(51) Int. Cl. H01F 27/29; H01F 27/02; H01F 27/24; H01F 27/28

(52) U.S. Cl. CPC H01F 27/292; H01F 27/2828; H01F 27/24; H01F 27/02

(57) ABSTRACT

A coil component includes a core having a winding core portion and one pair of guard portions, a terminal electrode provided on each guard portion, and a wire wound around the winding core portion and having both ends electrically connected to the terminal electrodes. Each guard portion has an inner end face, an outer end face, a bottom surface, a top surface, and two side surfaces. Each terminal electrode has a bottom surface electrode portion continuous over at least the bottom surface and an outer end face electrode portion on the outer end face. The bottom surface electrode portion has a side surface extension portion located lower than a lowest portion of the winding core portion. The outer end face electrode portion is connected to the bottom surface electrode portion, and both end edges of the outer end face electrode portion are located away from both the side surfaces.

### CROSS-REFERENCE TO RELATED APPLICATION

This application claims benefit of priority to Japanese Patent Application No. 2020-165297 filed Sep. 30, 2020, the entire content of which is incorporated herein by reference.

### BACKGROUND

### Technical Field

The present disclosure relates to a coil component.

### Background Art

There has hitherto been known one disclosed in Japanese Unexamined Patent Application Publication No. 2019-134040 as a coil component. The coil component has a core having a winding core portion and one pair of guard portions which are provided at both ends of the winding core portion, a terminal electrode which is provided on each of the one pair of guard portions, and a wire which is wound around the winding core portion and which has both ends electrically connected to the terminal electrodes.

Each guard portion has an inner end face which faces the winding core portion, an outer end face which faces away from the inner end face, a bottom surface which couples the inner end face and the outer end face and which is oriented toward a mounting board at the time of mounting, a top surface which faces away from the bottom surface, and two side surfaces which couple the inner end face and the outer end face and which couple the bottom surface and the top surface.

Each terminal electrode has a bottom surface portion electrode which is provided on the bottom surface of the guard portion, an outer end face portion electrode which is provided on the outer end face of the guard portion, and side surface portion electrodes which are provided on the side surfaces of the guard portion, and the bottom surface portion electrode, the outer end face portion electrode, and the side surface portion electrodes are connected to one another.

### SUMMARY

It has turned out that actual manufacture and use of the hitherto known coil component causes the following problems.

Both end edges in a width direction of each outer end face portion electrode are present at positions in contact with both the side surfaces of the guard portion. For this reason, at the time of holding both the side surfaces of the guard portion of the core from both sides with a chuck jig of a winding device and winding a wire around the core (hereinafter referred to as a winding process), the chuck jig may interfere with the outer end face portion electrode to cause peeling of or damage to the outer end face portion electrode. This may inhibit solder from wetting the outer end face portion electrode.

Each side surface portion electrode extends to a position higher than a bottom surface of the winding core portion. For this reason, the side surface portion electrode is present in a region (hereinafter referred to as an extension region of the side surface of the guard portion) which is an extension of the winding core portion at the side surface of the guard portion as viewed from a direction orthogonal to the side surface of the guard portion. When the extension regions of the side surfaces of the guard portion are held with the chuck jig in the winding process, the chuck jig interferes with the side surface portion electrodes. The extension regions of the side surfaces of the guard portion cannot be held with the chuck jig. For this reason, actions, such as holding the hitherto known coil component from both sides with a chuck jig designed so as not to interfere with the side surface portion electrodes, are taken. However, if core sizes become smaller, an area of a margin of each core to grip with a chuck jig becomes smaller, which makes it difficult to rotate the core about an axis of the core with a chuck jig and stably wind a wire around the core.

Accordingly, the present disclosure provides a coil component which allows reduction in damage to a terminal electrode by a chuck jig in a winding process and stabilization of winding of a wire around a core in the winding process.

A coil component according to one aspect of the present disclosure includes a core having a winding core portion and one pair of guard portions which are provided at both ends of the winding core portion, a terminal electrode which is provided on each of the one pair of guard portions, and a wire which is wound around the winding core portion and which has both ends electrically connected to the terminal electrodes. Each of the guard portions has an inner end face which faces the winding core portion, an outer end face which faces away from the inner end face, a bottom surface which couples the inner end face and the outer end face and which is oriented toward a mounting board at the time of mounting, a top surface which faces away from the bottom surface, and two side surfaces which couple the inner end face and the outer end face and which couple the bottom surface and the top surface. Each of the terminal electrodes has a bottom surface electrode portion which is provided to be continuous over a surface including at least the bottom surface of the guard portion and an outer end face electrode portion which is provided on the outer end face of the guard portion. The bottom surface electrode portion has a side surface extension portion which extends toward one of the side surfaces of the guard portion, and the side surface extension portion is present at a position lower than a portion closest to the bottom surface in the winding core portion in a height direction from the bottom surface toward the top surface. The outer end face electrode portion is connected to the bottom surface electrode portion, and both end edges of the outer end face electrode portion on both sides in a width direction, in which both the side surfaces of the guard portion face each other, are present at positions away from both the side surfaces of the guard portion.

According to the aspect, both the end edges of the outer end face electrode portion are present at the positions away from both the side surfaces of the guard portion. At the time of holding both the side surfaces of the guard portion of the core from both sides with a chuck jig of a winding device and winding the wire around the core (hereinafter referred to as a winding process), the chuck jig does not interfere with the outer end face electrode portion, and the outer end face electrode portion neither peel off nor is damaged.

Also, since the side surface extension portion of the bottom surface electrode portion is present at the position lower than the portion closest to the bottom surface in the winding core portion, the side surface extension portion is not present in a region (hereinafter referred to as an extension region of the side surface of the guard portion) which is an extension of the winding core portion at the side surface of the guard portion as viewed from a direction orthogonal to the side surface of the guard portion. For this reason, even if the extension region of the side surface of the guard portion is held with the chuck jig at the time of holding both the side surfaces of the guard portion of the core from both sides with the chuck jig, the chuck jig does not interfere with the side surface extension portion. This makes it possible to rotate the core about an axis of the core with the chuck jig and to stably wind the wire around the core.

It is thus possible to reduce damage to the terminal electrodes by the chuck jig in the winding process and to stabilize winding of the wire around the core in the winding process.

Preferably, in one embodiment of the coil component, the terminal electrodes include a first terminal electrode and a second terminal electrode which are provided on one of the guard portions and a third terminal electrode and a fourth terminal electrode which are provided on the other guard portion, and the wire includes a first wire which is electrically connected to the first terminal electrode and the third terminal electrode and a second wire which is electrically connected to the second terminal electrode and the fourth terminal electrode.

According to the embodiment, the coil component functions as a common mode choke coil.

Preferably, in one embodiment of the coil component, a size in the width direction of the outer end face electrode portion decreases from the bottom surface toward the top surface.

According to the embodiment, an inter-electrode gap between the outer end face electrode portion of the first terminal electrode and the outer end face electrode portion of the second terminal electrode can be increased from the bottom surface toward the top surface. That is, the inter-electrode gap can be secured at a position overlapping with an axis of the winding core portion at the outer end face of the guard portion as viewed from a direction of the axis of the winding core portion. For this reason, the chuck jig can also be brought into contact with the inter-electrode gap of the outer end face of the guard portion without interfering with the outer end face electrode portion. It is thus possible to hold the core in a more stable posture with the chuck jig. The same applies to the third and fourth terminal electrodes.

Additionally, a width on a side closer to the bottom surface of the outer end face electrode portion is large, and a fillet width after solder wetting is large. This improves visibility in inspection of a solder fillet after the coil component is mounted on the mounting board.

Preferably, in one embodiment of the coil component, the outer end face electrode portion does not overlap with an axis of the winding core portion as viewed from an axial direction of the winding core portion.

According to the embodiment, the inter-electrode gap between the outer end face electrode portion of the first terminal electrode and the outer end face electrode portion of the second terminal electrode can be secured at a position overlapping with the axis of the winding core portion at the outer end face of the guard portion as viewed from the direction of the axis of the winding core portion. For this reason, the chuck jig can also be brought into contact with the inter-electrode gap of the outer end face of the guard portion without interfering with the outer end face electrode portion. It is thus possible to hold the core in a more stable posture with the chuck jig. The same applies to the third and fourth terminal electrodes.

Preferably, in one embodiment of the coil component, a size in the width direction of a connection portion which is connected to the bottom surface electrode portion in the outer end face electrode portion is 75% or more and less than 100% (i.e., from 75% to less than 100%) of a size in the width direction of the bottom surface electrode portion.

According to the embodiment, a width of the connection portion connected to the bottom surface electrode portion in the outer end face electrode portion is large, and the fillet width after solder wetting is large. This improves the visibility in inspection of a solder fillet after the coil component is mounted on the mounting board.

Preferably, in one embodiment of the coil component, the outer end face electrode portion is present at a position lower than half of a size in the height direction of the guard portion.

According to the embodiment, the chuck jig can be brought into contact with a position overlapping with the axis of the winding core portion at the outer end face of the guard portion as viewed from the direction of the axis of the winding core portion without interfering with the outer end face electrode portion. It is thus possible to hold the core in a more stable posture with the chuck jig.

Preferably, in one embodiment of the coil component, the outer end face electrode portion is present at a position lower than one-third of the size in the height direction of the guard portion.

According to the embodiment, it is possible to bring the chuck jig into wider contact with the outer end face of the guard portion and to hold the core in a more stable posture with the chuck jig.

Preferably, in one embodiment of the coil component, a central portion in the width direction of the outer end face electrode portion is highest in the height direction of the outer end face electrode portion.

According to the embodiment, a natural fillet can be formed on the outer end face electrode portion.

Preferably, in one embodiment of the coil component, shapes of corners which are located on a side closer to the top surface and on respective sides closer to the side surfaces in the outer end face electrode portion are rounded shapes.

According to the embodiment, a natural fillet can be formed on the outer end face electrode portion.

Preferably, the coil component in one embodiment includes a magnetic plate which is fixed so as to lie astride the one pair of guard portions.

According to the embodiment, magnetism efficiency increases, and a desired inductance value is obtained with a smaller number of wires.

Preferably, in one embodiment of the coil component, the one guard portion has two leg portions on a side closer to the bottom surface, the bottom surface electrode portion of the first terminal electrode is provided on one of the leg portions, and the bottom surface electrode portion of the second terminal electrode is provided on the other leg portion. Also, the other guard portion has two leg portions on the side closer to the bottom surface, the bottom surface electrode portion of the third terminal electrode is provided on one of the leg portions, and the bottom surface electrode portion of the fourth terminal electrode is provided on the other leg portion.

According to the embodiment, the bottom surface electrode portions provided on the two leg portions, respectively, of the guard portion can be easily isolated by a dip method.

Preferably, in one embodiment of the coil component, an end edge on an inner side in the width direction of the outer end face electrode portion and an end edge on the inner side in the width direction of the bottom surface electrode portion are connected.

The inner side here refers to a center side in the width direction of the guard portion.

According to the embodiment, the outer end face electrode portion can be provided to be shifted to the inner side with respect to the bottom surface electrode portion. It is possible to locate an end edge on an outer side of the outer end face electrode portion further away from the side surface of the guard portion while securing a width of the outer end face electrode portion.

Preferably, in one embodiment of the coil component, the end edge on the inner side of the outer end face electrode portion and the end edge on the inner side of the bottom surface electrode portion lie on a same line.

According to the embodiment, it is possible to locate the end edge on the outer side of the outer end face electrode portion further away from the side surface of the guard portion while securing a larger width of the outer end face electrode portion.

Preferably, in one embodiment of the coil component, a thickness of the outer end face electrode portion is largest at a central portion in the height direction and the width direction of the outer end face electrode portion.

According to the embodiment, a thickness of the central portion of the outer end face electrode portion is large, and a fillet can be prevented from being formed to be excessively high. Additionally, since a thickness of an outer peripheral edge of the outer end face electrode portion is small, a fillet extends smoothly in a vertical direction. At the time of chucking the outer end face of the guard portion with the chuck jig, the outer end face electrode portion does not stand in the way of the chuck jig.

Preferably, in one embodiment of the coil component, each of the guard portions has a first convex curved surface between the outer end face and the side surface.

According to the embodiment, at the time of holding both the side surfaces of the guard portion of the core from both sides with the chuck jig, the core can be prevented from being broken. Additionally, fillets can be simultaneously formed so as to lie astride both the outer end face and the side surface of the guard portion. Specifically, since the fillet on the outer end face is higher, molten solder can run easily along the first convex curved surface toward the side surface.

Preferably, in one embodiment of the coil component, each of the guard portions has a second convex curved surface between the outer end face and the bottom surface.

According to the embodiment, molten solder can run easily along the second convex curved surface to the outer end face and the bottom surface, and a fillet can be formed so as to lie astride both the outer end face and the bottom surface.

Preferably, in one embodiment of the coil component, each of the guard portions has a third convex curved surface between the side surface and the bottom surface, and the side surface extension portion is located on the third convex curved surface and is not present at a position higher than the third convex curved surface in the height direction.

According to the embodiment, it is possible to widen a range within which the chuck jig can come into contact with the side surface of the guard portion without interfering with the side surface extension portion, at the time of holding both the side surfaces of the guard portion of the core from both sides with the chuck jig. The core can be stably held with the chuck jig.

Preferably, in one embodiment of the coil component, the outer end face electrode portion is higher than the side surface extension portion in the height direction.

According to the embodiment, visibility in inspection of a fillet to be formed on the outer end face electrode portion is improved.

The coil component according to the one aspect of the present disclosure allows reduction in damage to the terminal electrodes by the chuck jig in the winding process and stabilization of winding of the wire around the core in the winding process.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view, as viewed from a lower side, showing a coil component according to a first embodiment;

FIG. 2 is a view of the coil component as viewed from an L direction;

FIG. 3 is a view of the coil component as viewed from a W direction;

FIG. 4 is a sectional view taken along line A-A in FIG. 2;

FIG. 5 is a sectional view taken along line B-B in FIG. 3;

FIG. 6 is a perspective view showing a state where both side surfaces of a first guard portion of a core are held from both sides with a chuck jig;

FIG. 7 is a perspective view showing a state where the coil component is mounted on a mounting board;

FIG. 8 is a view, as viewed from an L direction, showing a coil component according to a second embodiment;

FIG. 9A is an LW sectional view, showing a coil component according to a third embodiment, of a part of the coil component;

FIG. 9B is a TL sectional view, showing the coil component according to the third embodiment, of a part of the coil component; and

FIG. 9C is a TW sectional view, showing the coil component according to the third embodiment, of a part of the coil component.

### DETAILED DESCRIPTION

A coil component according to one aspect of the present disclosure will be described below in more detail by means of embodiments illustrated in the drawings. Note that the drawings include schematics and may not reflect actual dimensions or ratios.

### First Embodiment

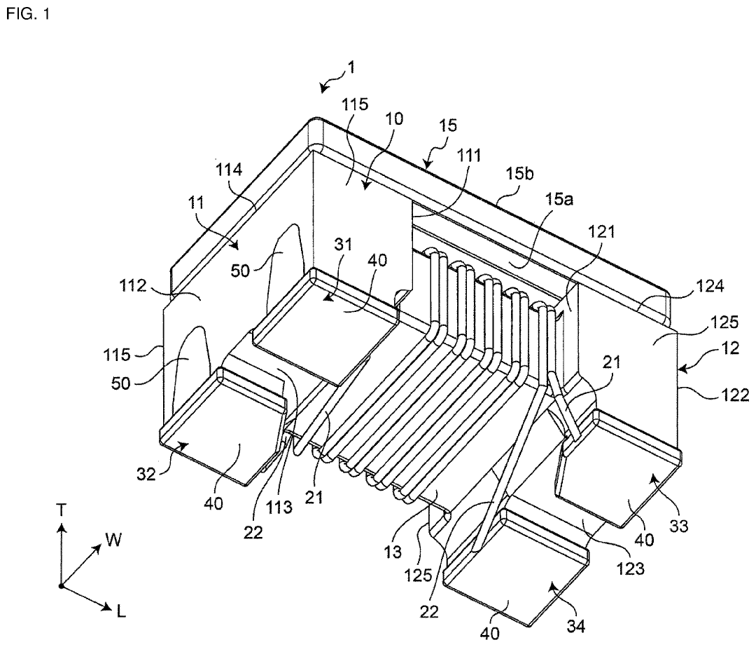

FIG. 1 is a perspective view, as viewed from a lower side, showing a coil component according to a first embodiment. As shown in FIG. 1, a coil component 1 includes a core 10, a first wire 21 and a second wire 22 which are wound around the core 10, a first terminal electrode 31, a second terminal electrode 32, a third terminal electrode 33, and a fourth terminal electrode 34 which are provided on the core 10 and to which the first and second wires 21 and 22 are electrically connected, and a magnetic plate 15 which is attached to the core 10.

The core 10 has a winding core portion 13 which has a shape extending in a fixed direction and around which the first and second wires 21 and 22 are wound, a first guard portion 11 which is provided at a first end in a direction, in which the winding core portion 13 extends, and juts out in a direction orthogonal to the direction, and a second guard portion 12 which is provided at a second end in the direction, in which the winding core portion 13 extends, and juts out in the direction orthogonal to the direction. The direction, in which the winding core portion 13 extends, is also referred to as an axial direction of the winding core portion 13. As a material for the core 10, for example, a magnetic substance, such as a sintered compact of ferrite or a molded body of a magnetic powder-containing resin, is preferable. The material, however, may be a non-magnetic substance, such as alumina or resin.

Note that, hereinafter, a bottom surface of the core 10 is assumed as a surface which is to be mounted on a mounting board and that a surface on an opposite side of the bottom surface of the core 10 is assumed as a top surface of the core 10. The axial direction of the winding core portion 13 is assumed as an L direction, a direction orthogonal to the L direction at the bottom surface of the core 10 is assumed as a W direction, and a direction in which the bottom surface and the top surface of the core 10 face each other is assumed as a T direction. The T direction is orthogonal to the L direction and the W direction. A side to which a positive direction of the T direction points is assumed as an upper side, and a side to which a negative direction of the T direction points is assumed as a lower side. That is, the bottom surface of the core 10 corresponds to a lower side in a perpendicular direction while the top surface of the core 10 corresponds to an upper side in the perpendicular direction. The L direction, the W direction, and the T direction are also referred to as a length direction, a width direction, and a height direction of the core 10, respectively.

The first guard portion 11 has an inner end face 111 which faces the winding core portion 13, an outer end face 112 which faces away from the inner end face 111, a bottom surface 113 which couple the inner end face 111 and the outer end face 112 and which is oriented toward a mounting board at the time of mounting, a top surface 114 which faces away from the bottom surface 113, and two side surfaces 115 which couple the inner end face 111 and the outer end face 112 and couple the bottom surface 113 and the top surface 114. An edge line is formed between each of the inner end face 111, the outer end face 112, the bottom surface 113, the top surface 114, and the side surfaces 115 and an adjacent surface.

Similarly, the second guard portion 12 has an inner end face 121 which faces the winding core portion 13, an outer end face 122 which faces away from the inner end face 121, a bottom surface 123 which couples the inner end face 121 and the outer end face 122 and which is oriented toward the mounting board at the time of mounting, a top surface 124 which faces away from the bottom surface 123, and two side surfaces 125 which couple the inner end face 121 and the outer end face 122 and couple the bottom surface 123 and the top surface 124.

The magnetic plate 15 is fixed so as to lie astride the first guard portion 11 and the second guard portion 12 as one pair. The magnetic plate 15 is attached to the top surface 114 of the first guard portion 11 and the top surface 124 of the second guard portion 12 with an adhesive. A material for the magnetic plate 15 is, for example, the same as that for the core 10. The core 10 and the magnetic plate 15 are both magnetic substances and constitute a closed magnetic circuit, which improves the efficiency of acquiring an inductance value. Thus, magnetism efficiency increases, and a desired inductance value is obtained with a smaller number of wires.

The first guard portion 11 has two leg portions on a side closer to the bottom surface 113. The first terminal electrode 31 is provided on one leg portion, and the second terminal electrode 32 is provided on the other leg portion. The second guard portion 12 has two leg portions on a side closer to the bottom surface 123. The third terminal electrode 33 is provided on one leg portion on the same side as the leg portion, on which the first terminal electrode 31 is provided, and the fourth terminal electrode 34 is provided on the other leg portion on the same side as the leg portion, on which the second terminal electrode 32 is provided. As shown in FIG. 1, the bottom surface 113 and the bottom surface 123 each refer to a portion including bottom surface portions of leg portions, side surface portions of a crotch portion between the leg portions, and a bottom surface portion of the crotch portion.

The first wire 21 and the second wire 22 are each, for example, an insulation-coated conductor wire obtained when a conductor wire made of metal, such as copper, is covered with a coating made of resin, such as polyurethane or polyamidimide. In the first wire 21, one end is electrically connected to the first terminal electrode 31, and the other end is electrically connected to the third terminal electrode 33. In the second wire 22, one end is electrically connected to the second terminal electrode 32, and the other end is electrically connected to the fourth terminal electrode 34. The first and second wires 21 and 22 and the first to fourth terminal electrodes 31 to 34 are connected by, for example, thermocompression bonding, brazing, or welding.

The first and second wires 21 and 22 are wound around the winding core portion 13 in the same direction. With this configuration, when signals opposite in phase, such as differential signals, are input to the first and second wires 21 and 22 in the coil component 1, magnetic fluxes which are generated by the first and second wires 21 and 22 cancel out each other to weaken functioning as an inductor and let the signals to pass. On the other hand, when in-phase signals, such as external noises, are input to the first and second wires 21 and 22, magnetic fluxes generated by the first and second wires 21 and 22 reinforce each other to strengthen functioning as an inductor and block passage of the noises. Thus, the coil component 1 functions as a common mode choke coil which attenuates a common-mode signal such as an external noise, while reducing a passage loss of a differential-mode signal such as a differential signal.

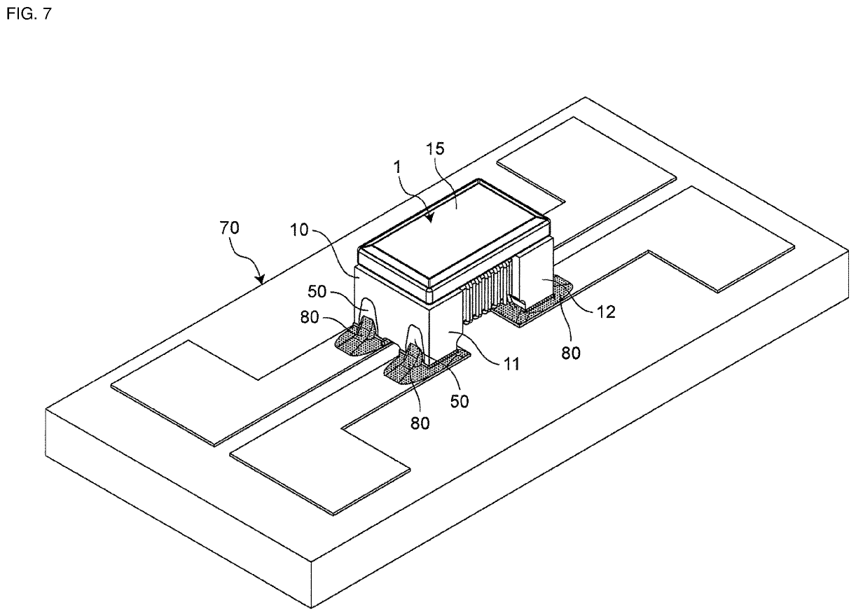

When the coil component 1 is mounted on a mounting board 70, as shown in FIG. 7, the bottom surface 113 of the first guard portion 11 and the bottom surface 123 of the second guard portion 12 face the mounting board 70. In this case, the axial direction of the winding core portion 13 and a principal surface of the mounting board 70 are parallel. That is, the coil component 1 is of a horizontal wound type in which winding axes for the first and second wires 21 and 22 are parallel to the mounting board 70.

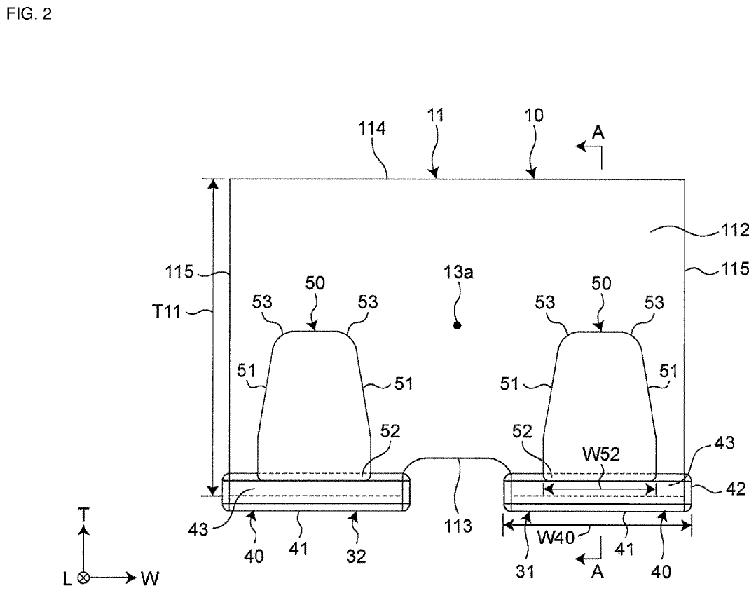

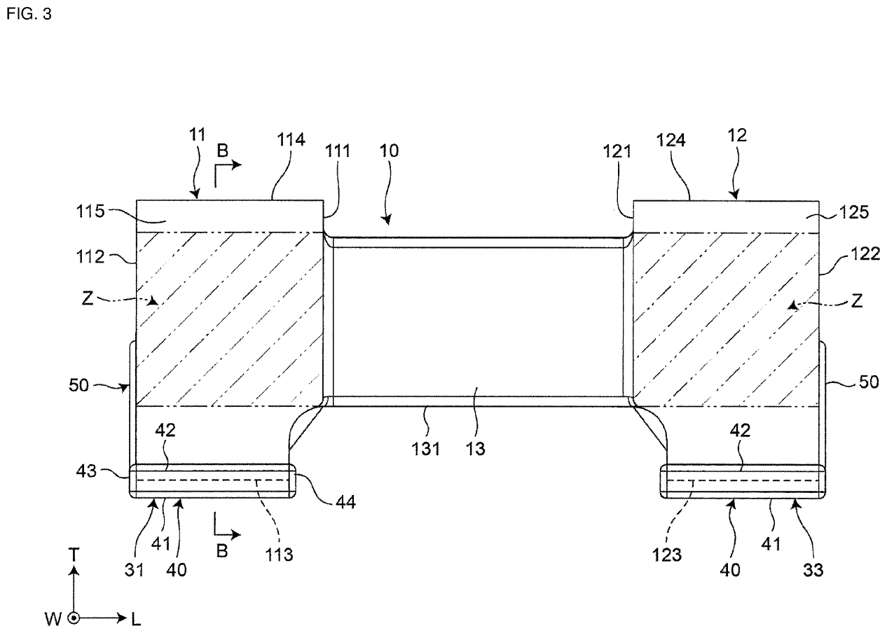

FIG. 2 is a view of the coil component as viewed from an L direction. FIG. 3 is a view of the coil component as viewed from a W direction. In FIGS. 2 and 3, the wires 21 and 22 and the magnetic plate 15 are not shown for convenience.

As shown in FIGS. 2 and 3, the first terminal electrode 31 has a bottom surface electrode portion 40 which is provided to be continuous over a surface including at least the bottom surface 113 of the first guard portion 11 and an outer end face electrode portion 50 which is provided on the outer end face 112 of the first guard portion 11. Similarly, the second terminal electrode 32, the third terminal electrode 33, and the fourth terminal electrode 34 each have the bottom surface electrode portion 40 and the outer end face electrode portion 50. The first terminal electrode 31 will be described below, and a description of the second, third, and fourth terminal electrodes 32, 33, and 34 will be omitted.

The bottom surface electrode portion 40 has a side surface extension portion 42 which extends toward the side surface 115 of the first guard portion 11. In the height direction (coincident with the T direction) from the bottom surface 113 toward the top surface 114, the side surface extension portion 42 is present at a position lower than a portion closest to the bottom surface 113 in the winding core portion 13. Specifically, the winding core portion 13 has a substantially quadrangular shape in cross-section, and the side surface extension portion 42 is present at a position lower than the bottom surface 131 of the winding core portion 13. Note that a sectional shape of the winding core portion may be a substantially hexagonal shape or a substantially elliptical shape other than the substantially quadrangular shape and that the portion closest to the bottom surface in the winding core portion corresponds to one side or a generating line of the winding core portion.

The outer end face electrode portion 50 is connected to the bottom surface electrode portion 40. The outer end face electrode portion 50 has end edges 51 on both sides in the width direction (coincident with the W direction), in which both the side surfaces 115 of the first guard portion 11 face each other. Both the end edges 51 of the outer end face electrode portion 50 are present at positions away from both the side surfaces 115 of the first guard portion 11.

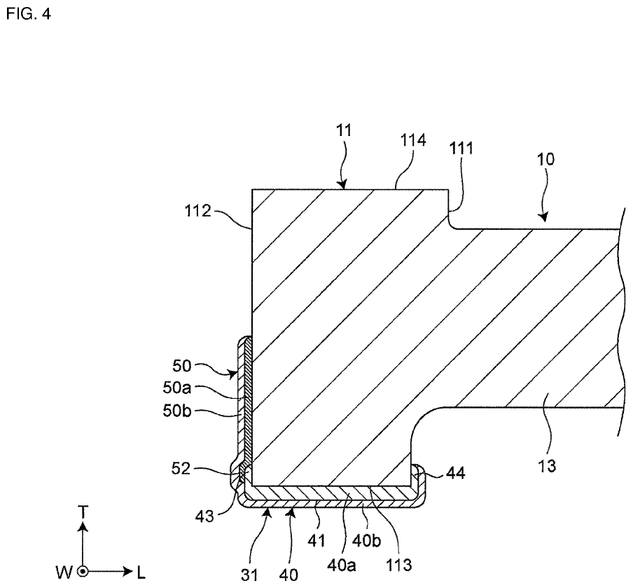

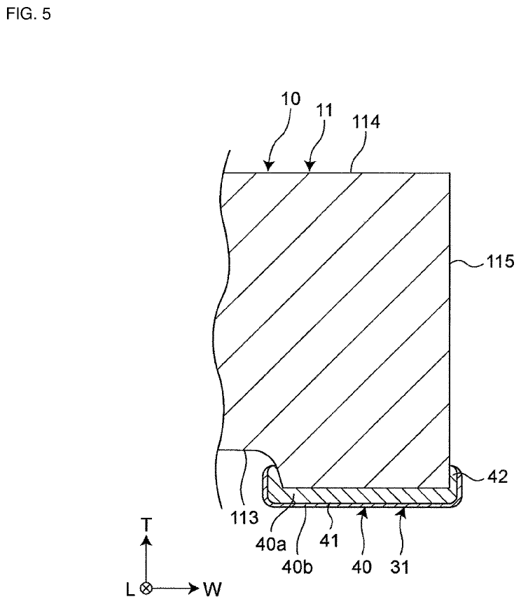

FIG. 4 is a sectional view taken along line A-A in FIG. 2. FIG. 5 is a sectional view taken along line B-B in FIG. 3. As shown in FIGS. 4 and 5, the bottom surface electrode portion 40 has a bottom surface portion 41 which faces the bottom surface 113 of the first guard portion 11, the side surface extension portion 42 that extends from the bottom surface portion 41 toward the side surface 115 of the first guard portion 11, an outer end face extension portion 43 which extends from the bottom surface portion 41 toward the outer end face 112 of the first guard portion 11, and an inner end face extension portion 44 which extends from the bottom surface portion 41 toward the inner end face 111 of the first guard portion 11. In this embodiment, the side surface extension portion 42 faces the side surface 115, the outer end face extension portion 43 faces the outer end face 112, and the inner end face extension portion 44 faces the inner end face 111.

The bottom surface electrode portion 40 is composed of a first layer 40a which is in contact with the core 10 and a second layer 40b which covers the first layer 40a. The first layer 40a is formed by, for example, applying an Ag paste containing Ag, Si, and resin to the bottom surface 113 of the first guard portion 11 by a dip method and firing the Ag paste. The second layer 40b is formed by, for example, forming films of Cu, Ni, and Sn in this order on the first layer 40a by electrolytic plating. Since the bottom surface electrode portions 40 are provided on the two leg portions, respectively, of the first guard portion 11, the bottom surface electrode portions 40 provided on the respective leg portions can be easily isolated by the dip method.

The outer end face electrode portion 50 faces the outer end face 112. The outer end face electrode portion 50 has a connection portion 52 which is connected to the bottom surface electrode portion 40. Specifically, the connection portion 52 is connected to the outer end face extension portion 43 and overlaps so as to cover a part of the outer end face extension portion 43.

The outer end face electrode portion 50 is composed of a first layer 50a which is in contact with the core 10 and a second layer 50b which covers the first layer 50a. The first layer 50a is formed by, for example, forming a film of Ni or Cu on the outer end face 112 of the first guard portion 11 by a sputtering method. The second layer 50b is formed by, for example, forming films of Cu, Ni, and Sn in this order on the first layer 50a by electrolytic plating.

The first layer 50a of the outer end face electrode portion 50 is formed so as to cover a part of the first layer 40a of the bottom surface electrode portion 40. That is, the first layer 50a of the connection portion 52 overlaps so as to cover a part of the first layer 40a of the outer end face extension portion 43. This is because the first layer 40a of the bottom surface electrode portion 40 is first formed, and the first layer 50a of the outer end face electrode portion 50 is then formed.

On the other hand, the second layer 50b of the outer end face electrode portion 50 is integral and continuous with the second layer 40b of the bottom surface electrode portion 40. This is because the second layer 50b of the outer end face electrode portion 50 and the second layer 40b of the bottom surface electrode portion 40 are simultaneously formed by plating. If the second layers 40b and 50b are integrally formed by plating, a portion which covers the first layer 50a of the outer end face electrode portion 50 is assumed as the second layer 50b of the outer end face electrode portion 50, and the remaining portion that covers the first layer 40a of the bottom surface electrode portion 40 is assumed as the second layer 40b of the bottom surface electrode portion 40, for convenience.

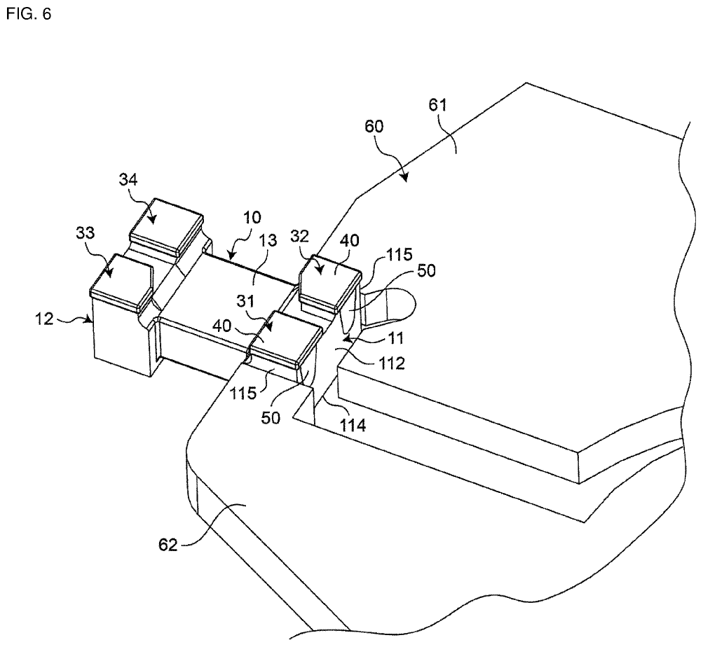

According to the above-described embodiment, both the end edges 51 of the outer end face electrode portion 50 are present at positions away from both the side surfaces 115 of the first guard portion 11, as shown in FIG. 2. At the time of holding both the side surfaces 115 of the first guard portion 11 of the core 10 from both sides with a chuck jig 60 of a winding device and winding the wires 21 and 22 around the core 10 (hereinafter referred to as a winding process), as shown in FIG. 6, the chuck jig 60 does not interfere with the respective outer end face electrode portions 50 of the first and second terminal electrodes 31 and 32, and the outer end face electrode portions 50 neither peel off nor are damaged. For this reason, solder is not inhibited from wetting the outer end face electrode portion 50.

Specifically, the chuck jig 60 has a first chuck portion 61 and a second chuck portion 62. The first chuck portion 61 is fixed to the device, and the second chuck portion 62 is movably attached to the device. A distal hook portion of the first chuck portion 61 and a distal hook portion of the second chuck portion 62 hold the core 10 from both sides. At this time, the distal hook portion of the first chuck portion 61 and the distal hook portion of the second chuck portion 62 do not interfere with the outer end face electrode portions 50.

Since the side surface extension portion 42 of the bottom surface electrode portion 40 is present at a position lower than the bottom surface 131 of the winding core portion 13, as shown in FIG. 3, the side surface extension portion 42 is not present in a region (hereinafter referred to as an extension region Z of the side surface 115 of the first guard portion 11, which is indicated by a hatch pattern with chain double-dashed lines in FIG. 3) which is an extension of the winding core portion 13 at the side surface 115 of the first guard portion 11 as viewed from a direction orthogonal to the side surface 115 of the first guard portion 11. Similarly, the side surface extension portion 42 is not present in the extension region Z of the side surface 125 of the second guard portion 12. For this reason, even if the extension regions Z of the side surfaces 115 of the first guard portion 11 are held with the chuck jig 60 at the time of holding both the side surfaces 115 of the first guard portion 11 of the core 10 from both sides with the chuck jig 60, as shown in FIG. 6, the chuck jig 60 does not interfere with the side surface extension portions 42. This makes it possible to rotate the core 10 about an axis of the core 10 with the chuck jig 60 and to stably wind the wires 21 and 22 around the core 10.

It is thus possible to reduce damage to the terminal electrodes 31 to 34 by the chuck jig 60 in the winding process and to stabilize winding of the wires 21 and 22 around the core 10 in the winding process.

Additionally, the coil component 1 has the bottom surface electrode portions 40 (the side surface extension portions 42) and the outer end face electrode portions 50. When the coil component 1 is mounted on the mounting board 70, as shown in FIG. 7, solder 80 wets the side surface extension portions 42 and the outer end face electrode portions 50 to increase fixing strength between the coil component 1 and the mounting board 70.

Preferably, as shown in FIG. 2, a size in the width direction of the outer end face electrode portion 50 decreases from the bottom surface 113 toward the top surface 114. That is, a distance between both the end edges 51 of the outer end face electrode portion 50 decreases toward the upper side (in the T direction). The distance between both the end edges 51 may decrease stepwise or gradually.

The above-described configuration makes it possible to increase an inter-electrode gap between the outer end face electrode portion 50 of the first terminal electrode 31 and the outer end face electrode portion 50 of the second terminal electrode 32 from the bottom surface 113 toward the top surface 114. That is, an inter-electrode gap can be secured at a position overlapping with an axis 13a of the winding core portion 13 at the outer end face 112 of the first guard portion 11 as viewed from a direction of the axis 13a of the winding core portion 13. For this reason, the chuck jig 60 can also be brought into contact with the inter-electrode gap of the outer end face 112 of the first guard portion 11 without interfering with the outer end face electrode portions 50. It is thus possible to hold the core 10 in a more stable posture with the chuck jig 60. The same applies to the third and fourth terminal electrodes 33 and 34.

Additionally, a width on a side closer to the bottom surface 113 of the outer end face electrode portion 50 is large, and a fillet width after solder wetting is large. This improves visibility in inspection of a solder fillet after the coil component 1 is mounted on the mounting board 70.

Preferably, as shown in FIG. 2, the outer end face electrode portion 50 does not overlap with the axis 13a of the winding core portion 13 as viewed from the direction of the axis 13a of the winding core portion 13. This makes it possible to secure the inter-electrode gap between the outer end face electrode portion 50 of the first terminal electrode 31 and the outer end face electrode portion 50 of the second terminal electrode 32 at a position overlapping with the axis 13a of the winding core portion 13 at the outer end face 112 of the first guard portion 11 as viewed from the direction of the axis 13a of the winding core portion 13. For this reason, the chuck jig 60 can also be brought into contact with the inter-electrode gap of the outer end face 112 of the first guard portion 11 without interfering with the outer end face electrode portions 50. It is thus possible to hold the core 10 in a more stable posture with the chuck jig 60. The same applies to the third and fourth terminal electrodes 33 and 34.

Preferably, as shown in FIG. 2, a size in the width direction (hereinafter referred to as a width W52) of the connection portion 52 connected to the bottom surface electrode portion 40 in the outer end face electrode portion 50 is about 75% or more and less than about 100% (i.e., from about 75% to less than about 100%) of a size in the width direction (hereinafter referred to as a width W40) of the bottom surface electrode portion 40. With the above-described configuration, the width W52 of the connection portion 52 of the outer end face electrode portion 50 is large, and the fillet width after solder wetting is large. This improves the visibility in inspection of a solder fillet after the coil component 1 is mounted on the mounting board 70. In contrast, if the width W52 of the connection portion 52 is less than about 75% of the width W40 of the bottom surface electrode portion 40, the fillet width is smaller. If the width W52 of the connection portion 52 is equal to the width W40 of the bottom surface electrode portion 40, the chuck jig 60 may interfere with the outer end face electrode portion 50.

Preferably, as shown in FIG. 2, the outer end face electrode portion 50 is present at a position lower than half of a size in the height direction (hereinafter referred to as a height T11) of the first guard portion 11. The height T11 of the first guard portion 11 refers to a maximum distance between the bottom surface 113 and the top surface 114 of the first guard portion 11. With this configuration, the chuck jig 60 can be brought into contact with a position overlapping with the axis 13a of the winding core portion 13 at the outer end face 112 of the first guard portion 11 without interfering with the outer end face electrode portions 50 as viewed from the direction of the axis 13a of the winding core portion 13. It is thus possible to hold the core 10 in a more stable posture with the chuck jig 60.

More preferably, the outer end face electrode portion 50 is present at a position lower than about one-third of the height T11 of the first guard portion 11. It is thus possible to bring the chuck jig 60 into wider contact with the outer end face 112 of the first guard portion 11 and to hold the core 10 in a more stable posture with the chuck jig 60.

Preferably, as shown in FIG. 2, a central portion in the width direction of the outer end face electrode portion 50 is highest in the height direction of the outer end face electrode portion 50. That is, the central portion in the width direction of the outer end face electrode portion 50 has a maximum height. Note that, as for the two outer end face electrode portions 50 provided on the first guard portion 11, each outer end face electrode portion 50 has the maximum height at its central portion. With this configuration, when solder wets the outer end face electrode portion 50 to an upper portion, a natural fillet can be formed on the outer end face electrode portion 50.

Preferably, as shown in FIG. 2, shapes of corners 53 which are located on a side closer to the top surface 114 and on respective sides closer to the side surfaces 115 in the outer end face electrode portion 50 are substantially rounded shapes. With this configuration, when solder wets the outer end face electrode portion 50 to the upper portion, a natural fillet can be formed on the outer end face electrode portion 50.

Preferably, as shown in FIG. 2, a thickness of the outer end face electrode portion 50 is largest at a central portion in the height direction and the width direction of the outer end face electrode portion 50. The thickness of the outer end face electrode portion 50 refers to a size in a direction orthogonal to the outer end face 112 of the first guard portion 11. With this configuration, a thickness of the central portion of the outer end face electrode portion 50 is large, and a fillet can be prevented from being formed to be excessively high. Additionally, since a thickness of an outer peripheral edge of the outer end face electrode portion 50 is small, a fillet extends smoothly in a vertical direction. At the time of chucking the outer end face 112 of the first guard portion 11 with the chuck jig 60, the outer end face electrode portion 50 does not stand in the way of the chuck jig 60.

Preferably, as shown in FIG. 2, the outer end face electrode portion 50 is higher than the side surface extension portion 42 of the bottom surface electrode portion 40 in the height direction. This improves the visibility in inspection of a fillet to be formed on the outer end face electrode portion 50.

### Second Embodiment

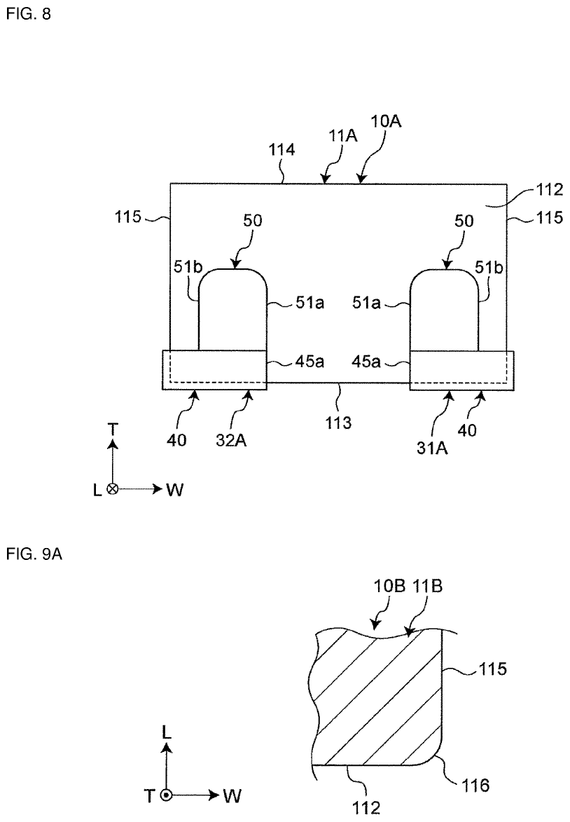

FIG. 8 is a view, as viewed from an L direction, showing a coil component according to a second embodiment. Wires and a magnetic plate are not shown in FIG. 8 for convenience. The second embodiment is different from the first embodiment in a shape of a core and a shape of a terminal electrode. Such different components will be described below. The other components are the same as those in the first embodiment. The components are denoted by the same reference characters as those in the first embodiment, and a description thereof will be omitted.

As shown in FIG. 8, in a core 10A of the coil component according to the second embodiment, a bottom surface 113 of a first guard portion 11A is flat and does not have two leg portions as in the first embodiment. Note that, although not shown, the same applies to a second guard portion.

In a first terminal electrode 31A, an end edge 51a on an inner side in a width direction of an outer end face electrode portion 50 and an end edge 45a on the inner side in the width direction of a bottom surface electrode portion 40 are connected. The same applies to a second terminal electrode 32A. Although not shown, the same applies to a third terminal electrode and a fourth terminal electrode. The inner side here refers to a center side in the width direction of the first guard portion 11A. With this configuration, the outer end face electrode portion 50 can be provided to be shifted to the inner side with respect to the bottom surface electrode portion 40. It is possible to locate an end edge 51b on an outer side of the outer end face electrode portion 50 further away from a side surface 115 of the first guard portion 11A while securing a width of the outer end face electrode portion 50.

Preferably, the end edge 51a on the inner side of the outer end face electrode portion 50 and the end edge 45a on the inner side of the bottom surface electrode portion 40 lie on the same line. It is thus possible to locate the end edge 51b on the outer side of the outer end face electrode portion 50 further away from the side surface 115 of the first guard portion 11A while securing a larger width of the outer end face electrode portion 50.

Note that although the end edge 51a on the inner side and the end edge 51b on the outer side of the outer end face electrode portion 50 are parallel, and the width of the outer end face electrode portion 50 does not change toward an upper side in this embodiment, the width of the outer end face electrode portion 50 may decrease or increase toward the upper side. Although the end edge 51a on the inner side of the outer end face electrode portion 50 and the end edge 45a on the inner side of the bottom surface electrode portion 40 lie on the same line, the end edge 51a on the inner side of the outer end face electrode portion 50 and the end edge 45a on the inner side of the bottom surface electrode portion 40 may intersect at one point.

### Third Embodiment

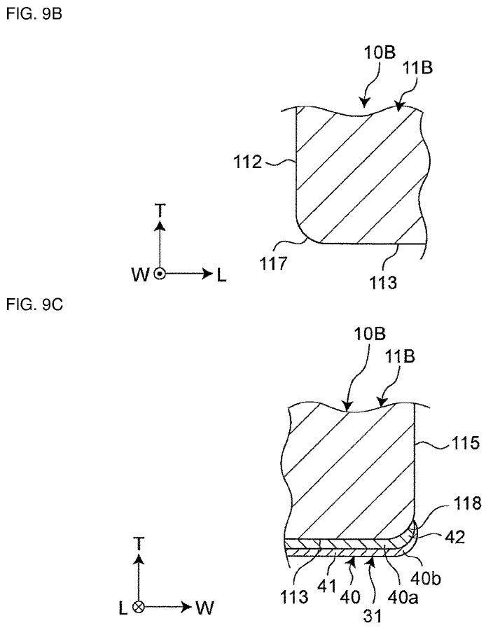

FIG. 9A is an LW sectional view, showing a coil component according to a third embodiment, of a part of the coil component. FIG. 9B is a TL sectional view, showing the coil component according to the third embodiment, of a part of the coil component. FIG. 9C is a TW sectional view, showing the coil component according to the third embodiment, of a part of the coil component. The third embodiment is different from the first embodiment in a shape of a core. Such a different component will be described below. The other components are the same as those in the first embodiment. The components are denoted by the same reference characters as those in the first embodiment, and a description thereof will be omitted.

As shown in FIG. 9A, in a core 10B of the coil component according to the third embodiment, a first guard portion 11B has a first convex curved surface 116 between an outer end face 112 and a side surface 115. Note that, although not shown, the same applies to a second guard portion. With this configuration, at the time of holding both the side surfaces 115 of the first guard portion 11B of the core 10B from both sides with a chuck jig, the core 10B can be prevented from being broken. Additionally, fillets can be simultaneously formed so as to lie astride both the outer end face 112 and the side surface 115 of the first guard portion 11B. Specifically, since the fillet on the outer end face 112 is higher, molten solder can run easily along the first convex curved surface 116 toward the side surface 115.

As shown in FIG. 9B, the first guard portion 11B has a second convex curved surface 117 between the outer end face 112 and a bottom surface 113. Note that, although not shown, the same applies to the second guard portion. With this configuration, molten solder can run easily along the second convex curved surface 117 to the outer end face 112 and the bottom surface 113, and a fillet can be formed so as to lie astride both the outer end face 112 and the bottom surface 113.

As shown in FIG. 9C, the first guard portion 11B has a third convex curved surface 118 between the side surface 115 and the bottom surface 113. A side surface extension portion 42 is located on the third convex curved surface 118 and is not present at a position higher than the third convex curved surface 118 in a height direction. That is, although the side surface extension portion 42 extends from the bottom surface 113 toward the side surface 115, the side surface extension portion 42 does not reach the side surface 115. Note that, although not shown, the same applies to the second guard portion. With this configuration, it is possible to widen a range within which the chuck jig can come into contact with the side surface 115 of the first guard portion 11B without interfering with the side surface extension portion 42, at the time of holding both the side surfaces 115 of the first guard portion 11B of the core 10B from both sides with the chuck jig. The core 10B can be stably held with the chuck jig.

Note that although the first guard portion 11B has the first, second, and third convex curved surfaces 116, 117, and 118 in this embodiment, at least one guard portion of the first guard portion and the second guard portion may have at least one convex curved surface of the first, second, and third convex curved surfaces.

Note that the present disclosure is not limited to the above-described embodiments and a design change can be made without departing from the scope of the present disclosure. For example, features of the first to third embodiments may be variously combined.

Although a coil component has two wires in the above-described first embodiment, the coil component may have one coil or three or more coils. Although the coil component is used as a common mode choke coil in the first embodiment, the coil component may be used as, for example, a wound coil, such as a transformer or a coupled inductor, in which a wire is wound around a winding core portion.

Although two terminal electrodes are provided on one guard portion in the first embodiment, one terminal electrode may be provided on one guard portion. Even in this case, each terminal electrode has a bottom surface electrode portion and an outer end face electrode portion, both end edges of the outer end face electrode portion are present at positions away from both side surfaces of the guard portion, and a side surface extension portion of the bottom surface electrode portion is present at a position lower than a portion closest to a bottom surface in a winding core portion. Alternatively, three or more terminal electrodes may be provided on one guard portion.

Although the coil component includes a magnetic plate in the first embodiment, the coil component may not include the magnetic plate. Although a size in a width direction of the outer end face electrode portion (a distance between both the end edges of the outer end face electrode portion) decreases from a bottom surface toward a top surface in the first embodiment, the size may increase or may not change.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A coil component comprising:
a core having a winding core portion and one pair of guard portions, configured such that one of the guard portions is provided on one end of the winding core portion and an other of the guard portions is provided on an other end of the winding core portion;
terminal electrodes provided on each of the guard portions; and
a wire which is wound around the winding core portion and which has both ends electrically connected to the terminal electrodes, wherein
each of the guard portions has an inner end face which faces the winding core portion, an outer end face which faces away from the inner end face, a bottom surface which couples the inner end face and the outer end face and which is oriented toward a mounting board at the time of mounting, a top surface which faces away from the bottom surface, and two side surfaces which couple the inner end face and the outer end face and which couple the bottom surface and the top surface,
each of the terminal electrodes has a bottom surface electrode portion which is provided to be continuous over a surface including at least the bottom surface of the guard portion and an outer end face electrode portion which is provided on the outer end face of the guard portion,
the bottom surface electrode portion has a side surface extension portion which extends toward one of the side surfaces of the guard portion, and the side surface extension portion is present at a position lower than a portion closest to the bottom surface in the winding core portion in a height direction from the bottom surface toward the top surface, and
the outer end face electrode portion is connected to the bottom surface electrode portion, and both end edges of the outer end face electrode portion on both sides in a width direction, in which both the side surfaces of the guard portion face each other, are present at positions away from both the side surfaces of the guard portion.

2. The coil component according to claim 1, wherein
the terminal electrodes include a first terminal electrode and a second terminal electrode which are provided on the one of the guard portions and a third terminal electrode and a fourth terminal electrode which are provided on the other of the guard portions, and
the wire includes a first wire which is electrically connected to the first terminal electrode and the third terminal electrode and a second wire which is electrically connected to the second terminal electrode and the fourth terminal electrode.

3. The coil component according to claim 2, wherein
a size in the width direction of the outer end face electrode portion decreases from the bottom surface toward the top surface.

4. The coil component according to claim 2, wherein
the outer end face electrode portion does not overlap with an axis of the winding core portion as viewed from an axial direction of the winding core portion.

5. The coil component according to claim 2, wherein
a size in the width direction of a connection portion which is connected to the bottom surface electrode portion in the outer end face electrode portion is from 75% to less than 100% of a size in the width direction of the bottom surface electrode portion.

6. The coil component according to claim 2, wherein
the outer end face electrode portion is present at a position lower than half of a size in the height direction of the guard portion.

7. The coil component according to claim 6, wherein
the outer end face electrode portion is present at a position lower than one-third of the size in the height direction of the guard portion.

8. The coil component according to claim 2, wherein
a central portion in the width direction of the outer end face electrode portion is highest in the height direction of the outer end face electrode portion.

9. The coil component according to claim 2, wherein
shapes of corners which are located on a side closer to the top surface and on respective sides closer to the side surfaces in the outer end face electrode portion are rounded shapes.

10. The coil component according to claim 2, further comprising:
a magnetic plate which is fixed so as to lie astride the one pair of guard portions.

11. The coil component according to claim 2, wherein
the one of the guard portions has two leg portions on a side closer to the bottom surface, the bottom surface electrode portion of the first terminal electrode is provided on one of the leg portions, and the bottom surface electrode portion of the second terminal electrode is provided on the other leg portion, and
the other of the guard portions has two leg portions on the side closer to the bottom surface, the bottom surface electrode portion of the third terminal electrode is provided on one of the leg portions, and the bottom surface electrode portion of the fourth terminal electrode is provided on the other leg portion.

12. The coil component according to claim 2, wherein
an end edge on an inner side in the width direction of the outer end face electrode portion and an end edge on the inner side in the width direction of the bottom surface electrode portion are connected.

13. The coil component according to claim 12, wherein
the end edge on the inner side of the outer end face electrode portion and the end edge on the inner side of the bottom surface electrode portion lie on a same line.

14. The coil component according to claim 1, wherein
a thickness of the outer end face electrode portion is largest at a central portion in the height direction and the width direction of the outer end face electrode portion.

15. The coil component according to claim 1, wherein
each of the guard portions has a first convex curved surface between the outer end face and the side surface.

16. The coil component according to claim 1, wherein
each of the guard portions has a second convex curved surface between the outer end face and the bottom surface.

17. The coil component according to claim 1, wherein
each of the guard portions has a third convex curved surface between the side surface and the bottom surface, and
the side surface extension portion is located on the third convex curved surface and is not present at a position higher than the third convex curved surface in the height direction.

18. The coil component according to claim 1, wherein
the outer end face electrode portion is higher than the side surface extension portion in the height direction.

19. The coil component according to claim 3, wherein
the outer end face electrode portion does not overlap with an axis of the winding core portion as viewed from an axial direction of the winding core portion.

20. The coil component according to claim 3, wherein
a size in the width direction of a connection portion which is connected to the bottom surface electrode portion in the outer end face electrode portion is from 75% to less than 100% of a size in the width direction of the bottom surface electrode portion.
